(19) United States
(12) Patent Application Publication
(10) Pub. No.: US 2018/0217007 A1
(43) Pub. Date: Aug. 2, 2018

(54) TEMPERATURE SENSOR

(71) Applicant: MITSUBISHI MATERIALS CORPORATION, Tokyo (JP)

(72) Inventors: Noriaki Nagatomo, Naka-shi (JP); Fumio Matsumoto, Chichibu-gun (JP); Hitoshi Inaba, Naka-shi (JP); Kazuta Takeshima, Naka-shi (JP); Kunio Yamaguchi, Chichibu-gun (JP); Hiroshi Tanaka, Naka-shi (JP)

(73) Assignee: MITSUBISHI MATERIALS CORPORATION, Tokyo (JP)

(21) Appl. No.: 15/748,202

(22) PCT Filed: Jul. 11, 2016
(86) PCT No.: PCT/JP2016/003272

§ 371 Date: Jan. 29, 2018

(30) Foreign Application Priority Data
Jul. 30, 2015 (JP) 2015-150529

(51) Int. Cl. G01K 7/22; G01K 1/12

(52) U.S. Cl. CPC G01K 7/223; G01K 1/12

(57) ABSTRACT

A temperature sensor comprises: a pair of lead frames; a sensor portion connected to the lead frames; and an insulating holding part holding the lead frames, wherein the sensor portion comprises: an insulating film having the lead frames bonded on an upper surface; a thermistor portion provided to the insulating film; a pair of electrodes formed on the thermistor portion; a pair of pattern electrodes patterned in the upper surface of the insulating film; and a pair of insulating protective tapes bonded to each other to hold the lead frames and the sensor in a vertical direction, wherein both sides of the insulating film are arranged in the vicinity of and inside outer corners on bonding surface sides of the lead frames, and both sides of the protective tapes are bent outward from both sides of the insulating film toward an upper surface side.

### BACKGROUND OF THE INVENTION

### Field of the Invention

The present invention relates to a temperature sensor appropriate for measuring a temperature of a heating roller of a copier, a printer, or the like and having excellent responsiveness.

### Description of the Related Art

Generally, in a heating roller used for a copier or a printer, a temperature sensor is installed in contact with the heating roller to measure its temperature. As such a temperature sensor, for example, Japanese Unexamined Patent Application Publication No. 2000-74752 (Patent document 1) proposes a temperature sensor including a pair of lead frames, a heat sensitive element arranged and connected between the lead frames, a holding part formed at end portions of the pair of lead frames, and a protective tape (a thin film sheet) provided in one surface of the lead frames and the heat sensitive element and brought into contact with a heating roller.

In Patent Document 1, as a heat sensitive element, a thin film thermistor having a heat sensitive film formed in one surface of an insulating substrate such as alumina is adopted in addition to a bead thermistor or a chip thermistor.

Also, in recent years, as a film-type temperature sensor which has excellent flexibility and can be thinned as a whole, temperature sensors having thin film thermistors formed in insulating films have been developed. For example, Japanese Unexamined Patent Application Publication No. 2014-52228 (Patent Document 2) proposes a temperature sensor including a pair of lead frames, a sensor portion connected to the pair of lead frames, and an insulating holding part fixed to the pair of lead frames and configured to hold the lead frames.

In such a temperature sensor, a sensor portion includes an insulating film, a thin film thermistor portion made of a thermistor material that is patterned on a surface of the insulating film, a pair of comb-type electrodes having a plurality of comb parts on at least one of upper and lower sides of the thin film thermistor portion and patterned so as to face each other, and a pair of pattern electrodes connected to the pair of comb-type electrodes and patterned on the surface of the insulating film, wherein the pair of lead frames extend and are bonded to the surface of the insulating film so that the thin film thermistor portion is arranged between the pair of lead frames, and are connected to a pair of pattern electrodes.

### PRIOR ART DOCUMENTS

### Patent Documents

[Patent Document 1] Japanese Unexamined Patent Application Publication No. 2000-74752

[Patent Document 2] Japanese Unexamined Patent Application Publication No. 2014-52228

### SUMMARY OF THE INVENTION

### Problems to be Solved by the Invention

The above-described conventional techniques have the following problems.

That is, in the technique disclosed in Japanese Unexamined Patent Application Publication No. 2000-74752, as illustrated in FIG. 5, when the sensor is brought into contact with an object to be measured such as the heating roller, since outer corners 2b of a pair of lead frames 2 are brought into contact with the object to be measured such as the heating roller via thin protective tapes 9A and 9B, there is a concern regarding damage of the object to be measured due to the outer corners 2b with an edge shape. Note that reference numeral 101 in FIG. 5 is a chip thermistor.

Also, in the techniques disclosed in Japanese Unexamined Patent Application Publication No. 2014-52228, like in the technique disclosed in Japanese Unexamined Patent Application Publication No. 2000-74752, when a protective tape is also attempted to be used while bonded to a contact surface side of the insulating film, the object to be measured is not easily damaged due to the insulating film arranged between the lead frame and the protective tape, but there is a concern in that the heat capacity and the contact area are increased because a wider protective tape overlaps and is bonded to a wide insulating film, which may lower responsiveness.

The present invention was made in view of the above-described problems, and an objective of the present invention is to provide a temperature sensor in which an object to be measured is not easily damaged when the temperature sensor is brought into contact with and performs temperature measurement on the object to be measured and which has excellent responsiveness.

### Means for Solving the Problems

The present invention adopts the following configuration to solve the above-described problems. Specifically, a temperature sensor according to a first aspect of the present invention comprises: a pair of lead frames; a sensor portion connected to the pair of lead frames; and an insulating holding part fixed to the pair of lead frames and configured to hold the pair of lead frames, wherein the sensor portion comprises: an insulating film having an upper surface to which the pair of lead frames are bonded; a thin film thermistor portion made of a thermistor material that is patterned on the upper surface of the insulating film; a pair of comb-type electrodes having a plurality of comb parts on at least one of upper and lower sides of the thin film thermistor portion and patterned so as to face each other; a pair of pattern electrodes each having one end connected to the pair of comb-type electrodes and the other end connected to the pair of lead frames and patterned on the upper surface of the insulating film; and a pair of insulating protective tapes bonded to each other to hold the pair of lead frames and the sensor portion in a vertical direction, wherein both sides of the insulating film are arranged in the vicinity of and inside outer corners on bonding surface sides of the pair of lead frames, and both sides of the pair of protective tapes are bent outward from both sides of the insulating film toward an upper surface side.

In this temperature sensor according to the present invention, since both sides of the insulating film are arranged in the vicinity of and inside the outer corners on the bonding surface side of the pair of lead frames and both sides of the pair of protective tapes are bent outward from both sides of the insulating film toward the upper surface side, the object to be measured is not easily damaged and thus good responsiveness can be obtained.

Specifically, stepped portions are formed in the vicinities of the outer corners due to both sides of the insulating film arranged inside the vicinities of the outer corners of the lead frames and a slight gap is generated between the protective tapes and the lead frame due to such stepped portions so that the portion in which the outer corners are present does not easily hit the object to be measured and damage hardly occurs when lower surfaces of the protective tapes are brought into contact with the object to be measured. Furthermore, both sides of the protective tapes are bent from further inward than the outer corners of the pair of lead frames due to the insulating film having a narrow width and the stepped portions, a contact surface with the object to be measured is reduced, and thus responsiveness is improved. In addition, since the insulating film that is arranged further inward than the outer corners of the lead frames has a narrow width, the heat capacity becomes small and thus good responsiveness can be obtained. Furthermore, since both sides of the protective tapes are bent toward the upper surface side, it is possible to prevent both sides of the protective tapes from coming into contact with the object to be measured and prevent both sides of the protective tapes from damaging the object to be measured.

A temperature sensor according to a second aspect of the present invention is characterized in that, in the temperature sensor of the first aspect of the present invention, the protective tape on the upper surface side may be bonded to the protective tape on a lower surface side in a state in which a pulling force directed from both sides of the protective tape toward a central portion thereof is applied.

Specifically, in the temperature sensor, since the protective tape on the upper surface side is bonded to the protective tape on the lower surface side in a state in which a pulling force directed from both sides toward the central portion is applied, the bonded upper and lower protective tapes are bent upward at the outsides of both sides of the insulating film due to the pulling force of the protective tape on the upper surface side and its shape is maintained.

A temperature sensor according to a third aspect of the present invention is characterized in that, in the first or second aspect of the present invention, distal end portions of the pair of lead frames may be connected to the pattern electrodes closer to distal end sides than the thin film thermistor portion and be formed to be wider inward than proximal end sides.

Specifically, in such a temperature sensor, since the distal end portions of the pair of lead frames are connected to the pattern electrodes closer to the distal end sides than the thin film thermistor portion and are formed to be wider inward than the proximal end sides, it is possible to increase a bonding area with the insulating film arranged further inward than the outer corners and having a small bonding area using the wide distal end portion so as to keep the sensor portion flat and stable. Note that, since the distal end portions of the lead frames are arranged closer to the distal end sides than the thin film thermistor portion and are connected to the pattern electrodes, the area of the thin film thermistor portion is not narrowed even when the distal end portions are made wider inward.

### Effects of the Invention

According to the present invention, the following effects can be obtained.

Specifically, according to the temperature sensor of the present invention, since both sides of the insulating film are arranged in the vicinity of and inside the outer corners on the bonding surface side of the pair of lead frames and both sides of the pair of the protective tapes are bent outward from both sides of the insulating film toward the upper surface side, the object to be measured is not easily damaged and thus good responsiveness can be obtained.

Therefore, according to the temperature sensor of the present invention, since damage can be prevented even when the temperature sensor is brought into contact with the object to be measured and thus high responsiveness can also be obtained, the temperature sensor is appropriate for measuring a temperature of a heating roller of a copier, a printer, or the like.

### BRIEF DESCRIPTION OF THE DRAWINGS

FIG. 1(a) is a plan view illustrating an embodiment of a temperature sensor according to the present invention and FIG. 1(b) is a cross-sectional view taken along line A-A.

FIG. 2 is a plan view showing a sensor portion in the present embodiment.

FIG. 3(a) is a plan view for describing a step of forming a thin film thermistor portion in the present embodiment and FIG. 3(b) is a plan view for describing a step of forming an electrode in the present embodiment.

FIG. 4 is a plan view for describing a step of bonding a lead frame in the present embodiment.

FIG. 5 is a cross-sectional view illustrating a conventional example of a temperature sensor according to the present invention.

### DESCRIPTION OF THE EMBODIMENTS

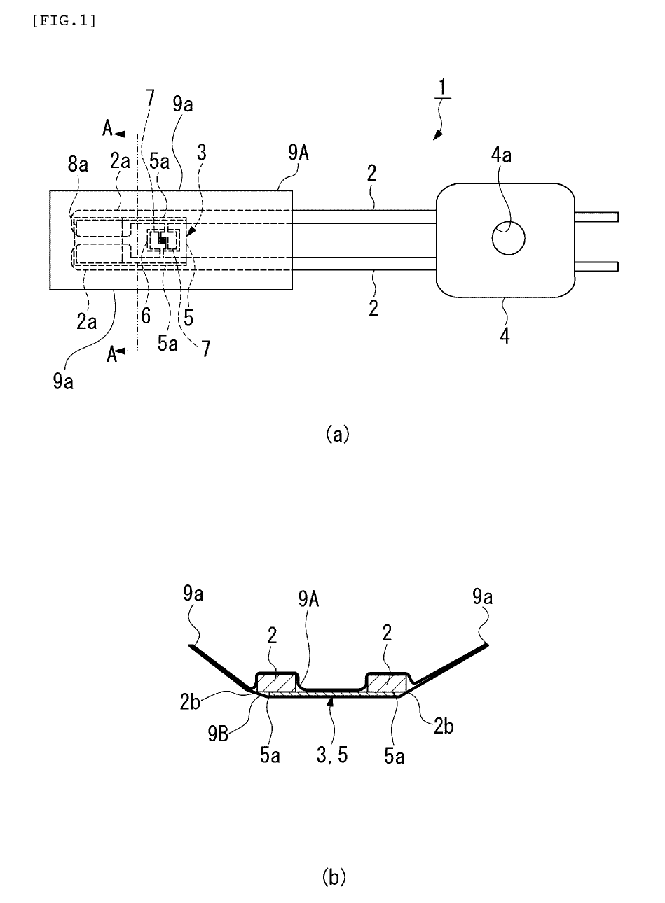

An embodiment of a temperature sensor according to the present invention will be described below with reference to FIGS. 1 to 4. Note that, in some of the drawings used in the following description, the scale is appropriately changed as necessary to set each component to have a size that is recognizable or easy to recognize.

As described in FIG. 1, a temperature sensor 1 according to the present embodiment comprises a pair of lead frames 2, a sensor portion 3 connected to the pair of lead frames 2, and an insulating holding part 4 fixed to the pair of lead frames 2 and configured to hold the pair of lead frames 2.

The sensor portion 3 comprises an insulating film 5 having an upper surface to which the pair of lead frames 2 are bonded, a thin film thermistor portion 6 patterned on the upper surface of the insulating film 5 using a thermistor material, a pair of comb-type electrodes 7 having a plurality of comb parts 7a on the thin film thermistor portion 6 and patterned so as to face each other, a pair of pattern electrodes 8 whose one ends are connected to the pair of comb-type electrodes 7 and whose the other ends are connected to the pair of lead frames 2, and patterned on the upper surface of the insulating film 5, and a pair of insulating protective tapes 9A and 9B bonded to each other to hold the pair of lead frames 2 and the sensor portion 3 in a vertical direction.

Both sides 5a of the insulating film 5 are arranged in the vicinity of and inside outer corners 2b on a bonding surface side of the pair of lead frames 2. In other words, a width of the insulating film 5 is set to be slightly smaller than distances between the outer corners 2b of the pair of lead frames 2.

In addition, both sides 9a of the pair of protective tapes 9A and 9B are bent outward from both sides 5a of the insulating film 5 toward the upper surface side thereof. In other words, widths of the pair of protective tapes 9A and 9B are set to be wider than widths of the pair of lead frames 2, and the pair of protective tapes 9A and 9B are bent in a valley fold shape along both sides 5a of the insulating film 5.

Note that the bent state is maintained by bonding a protective tape 9A on the upper surface side to which a pulling force directed from both sides of the protective tape toward a central portion thereof is applied to a protective tape 9B on a lower surface side.

Distal end portions 2a of the pair of lead frames 2 are connected to pattern electrodes 8 closer to distal end sides than the thin film thermistor portion 6 and are formed to be wider inward than the proximal end sides.

Wide pads 8a are formed at distal end sides of the pair of pattern electrodes 8 to correspond to the distal end portions 2a of the lead frames 2. The pair of lead frames 2 are bonded to the pads 8a using an adhesive such as a solder material or a conductive resin adhesive, or through resistance welding.

Note that, in the temperature sensor 1 according to the present embodiment, an insulating protective film 10 is formed above the insulating film 5 so as to cover the pattern electrodes 8 excluding the pads 8a, the thin film thermistor portion 6, and a comb-type electrode 7.

The insulating film 5 has a substantially rectangular shape, for example, is formed in a strip shape with a polyimide resin sheet having a thickness of 7.5 to 125 μm. Note that, although the insulating film 5 can be prepared using polyethylene terephthalate (PET), polyethylene naphthalate (PEN), or the like, a polyimide film is preferable because a maximum operating temperature is as high as 230° C. for the purpose of measuring a temperature of a heating roller.

The thin film thermistor portion 6 is arranged on a proximal end side of the insulating film 5 and is formed of, for example, a TiAlN thermistor material. Particularly, the thin film thermistor portion 6 is made of a metal nitride represented by a general formula: TiₓAl_{y}N_{z} (where 0.70≤y/(x+y)≤0.95, 0.4≤z≤0.5, and x+y+z=1), wherein the crystal structure thereof is a hexagonal wurtzite-type single phase.

The pattern electrodes 8 and the comb-type electrode 7 include a bonding layer made of Cr or NiCr having a film thickness of 5 to 100 nm formed on the thin film thermistor portion 6 and an electrode layer made of a noble metal such as Au having a film thickness of 50 to 1000 nm formed on the bonding layer.

The pair of comb-type electrodes 7 are formed in a comb-type pattern in which comb parts 7a are alternately arranged to face each other.

The comb parts 7a extend along an extending direction of the insulating film 5. Specifically, when a back surface side of the insulating film 5 is brought into contact with a rotating heating roller and is subjected to temperature measurement, since the insulating film is curved with a curvature in its extending direction, bending stress is also applied to the thin film thermistor portion 6 in the same direction. At this time, the comb parts 7a extending in the same direction reinforces the thin film thermistor portion 6, and the occurrence of cracks can be suppressed.

The protective film 10 is an insulating resin film or the like and, for example, a polyimide film having a thickness of 20 μm is adopted as the protective film 10.

The protective tapes 9A and 9B are made of a fluorocarbon resin such as Teflon (registered trademark).

Note that an attachment hole 4a is formed in the holding part 4.

A method for manufacturing the temperature sensor 1 will be described below with reference to FIGS. 1 to 4.

The method for manufacturing the temperature sensor 1 according to the present embodiment includes a thin film thermistor portion formation step of patterning the thin film thermistor portion 6 on a surface of the insulating film 5, an electrode formation step of arranging the pair of comb-type electrodes 7 facing each other on the thin film thermistor portion 6 and patterning the pair of pattern electrodes 8 on the surface of the insulating film 5, a protective film formation step of forming the protective film 10 on the insulating film 5, a lead frame connection step of connecting the lead frames 2 to the sensor portion 3, and a protective tape bonding step of holding the lead frames 2 and the sensor portion 3 in a vertical direction by the protective tapes 9A and 9B and bonding the protective tapes 9A and 9B to each other.

As an example of amore specific manufacturing method, a thermistor film made of TiₓAl_{y}N_{z} (where x=0.09, y=0.43, and z=0.48) is formed with a film thickness of 200 nm on the insulating film 5 made of a polyimide film having a thickness of 50 μm through a reactive sputtering method using a Ti—Al alloy sputtering target in a nitrogen-containing atmosphere. Preparation is performed in a state in which sputtering conditions at this time are an ultimate vacuum of 5×10⁻⁶ Pa, a sputtering gas pressure of 0.4 Pa, and a target input power (output) of 200 W in a mixed gas atmosphere of Ar gas+nitrogen gas at a nitrogen gas fraction of 20%.

Patterning is performed as follows: after a resist solution has been coated on the deposited thermistor film using a spin coater, pre-baking is performed at a temperature of 110° C. for 1.5 minutes; after exposure by an exposure device, any unnecessary portions are removed by a developing solution, and then post-baking is performed at a temperature of 150° C. for 5 minutes. After that, any unnecessary portion of the TiₓAl_{y}N_{z} thermistor film is subject to wet etching using a commercially available Ti etchant, and then the resist is stripped so as to form the thin film thermistor portion 6 as desired, as shown in FIG. 3(a).

Subsequently, a bonding layer made of a Cr film having a film thickness of 20 nm is formed on the thin film thermistor portion 6 and the insulating film 5 by a sputtering method. In addition, an electrode layer of an Au film having a film thickness of 100 nm is formed on this bonding layer by a sputtering method.

Subsequently, patterning is performed as follows: after a resist solution has been coated on the deposited electrode layer using a spin coater, pre-baking is performed at a temperature of 110° C. for 1.5 minutes; after exposure by an exposure device, any unnecessary portion is removed by a developing solution, and then post-baking is performed at a temperature of 150° C. for 5 minutes. After that, any unnecessary electrode portion is subject to wet etching using a commercially available Au etchant and Cr etchant in that order, and then the resist is stripped so as to form the comb-type electrode 7 and the pattern electrodes 8 as desired, as shown in FIG. 3(b).

In addition, a polyimide varnish is applied on a predetermined portion of the surface of the insulating film 5 by a printing method and cured at 180° C. for 30 minutes so as to form the polyimide protective film 10 having a thickness of 20 μm.

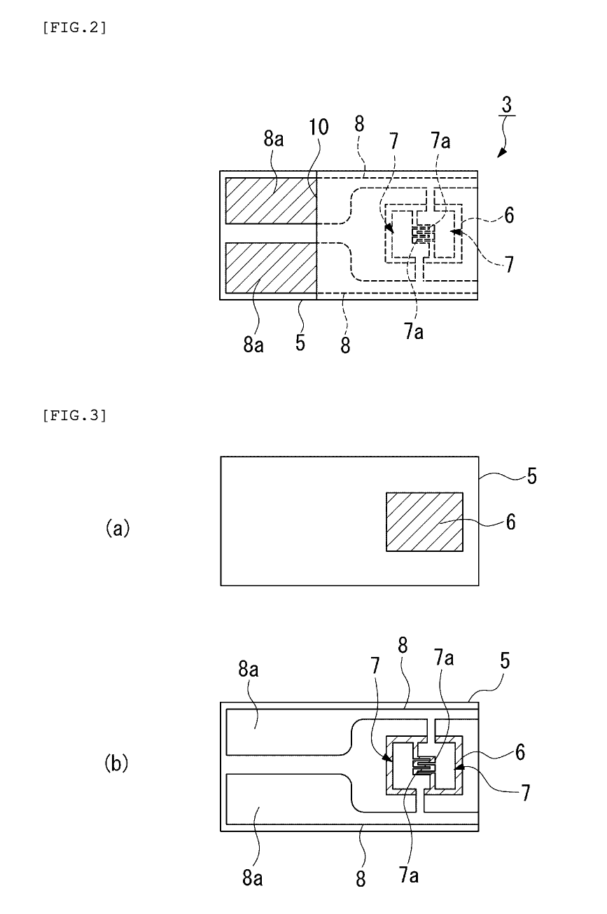

Subsequently, the pair of pads 8a is formed by performing Ni plating on regions serving as the pads 8a as illustrated in FIG. 2.

Note that, when a plurality of sensor portions 3 are prepared at the same time, a plurality of thin film thermistors portion 6, a plurality of comb-type electrodes 7, a plurality of pattern electrodes 8, a plurality of protective films 10, and a plurality of pads 8a are formed on a large sheet of the insulating film 5 as described above, and then each sensor portion 3 may be cut from the large sheet.

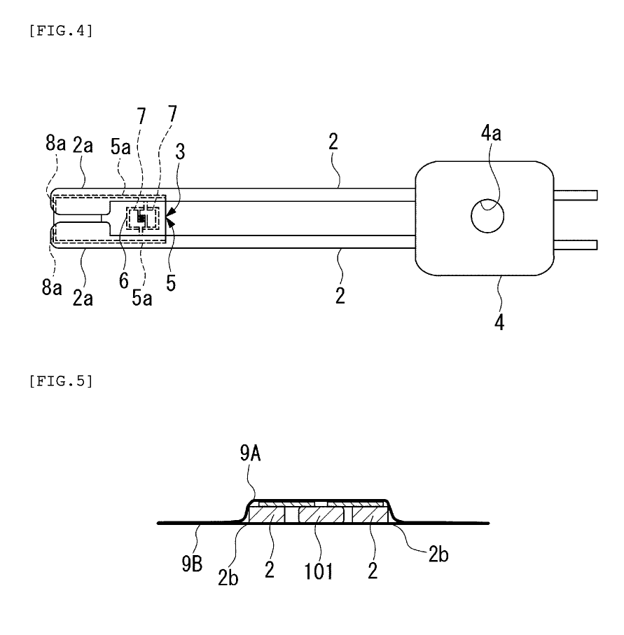

Subsequently, as illustrated in FIG. 4, the distal end portions 2a of the lead frames 2 are bonded to the pair of pads 8a using resistance welding.

In addition, the sensor portion 3 and the lead frames 2 are held by the protective tapes 9A and 9B in a vertical direction, and then the bonding surfaces at both sides 9a of the pair of protective tapes 9A and 9B are bonded by press. At this time, the protective tape 9A on the upper surface side is bonded to the protective tape 9B on the lower surface side in a state in which a pulling force directed from both sides toward the central portion thereof was applied. Thus, as illustrated in FIG. 1(b), the protective tape 9B on the lower surface side is pulled inward by the protective tape 9A on the upper surface side so that both sides 9a of the pair of protective tapes 9A and 9B are bent outward from both sides 5a of the insulating film 5 toward the upper surface side, and the temperature sensor 1 is prepared.

As described above, in the temperature sensor 1 according to the present embodiment, since both sides 5a of the insulating film 5 are arranged in the vicinity of and inside the outer corners 2b on the bonding surface sides of the pair of lead frames 2 and both sides 9a of the pair of protective tapes 9A and 9B are bent outward from both sides 5a of the insulating film 5 toward the upper surface side, it is difficult for the outer corners 2b of the lead frames 2 to come into contact with an object to be measured, and good responsiveness can be obtained due to the insulating film 5 having a narrow width.

Specifically, since stepped portions are formed in the vicinity of the outer corners 2b due to both sides 5a of the insulating film 5 arranged inside the vicinities of the outer corners 2b of the lead frames 2, and thus a slight gap is generated between the protective tapes 9A and 9B bent outward from such a stepped portion and the lead frames 2, a portion in which the outer corners 2b is arranged does not easily hit the object to be measured and thus damage does not easily occur when a lower surface of the protective tape 9B on the lower surface side is brought into contact with the object to be measured.

In addition, both sides 9a of the protective tapes 9A and 9B are bent at further inward than the outer corners 2b of the pair of lead frames 2 due to the insulating film 5 having the narrow width and the stepped portion, a contact surface with the object to be measured is reduced, and thus responsiveness is improved. Moreover, since the insulating film 5 that is arranged further inward than the outer corners 2b of the lead frames 2 has a narrow width, the heat capacity becomes small and thus good responsiveness can be obtained. Furthermore, since both sides of the pair of protective tapes 9A and 9B are bent toward the upper surface side, it is possible to prevent both sides 9a of the pair of protective tapes 9A and 9B from coming into contact with the object to be measured and prevent both sides 9a of the pair of protective tapes 9A and 9B from damaging the object to be measured.

Further, since the protective tape 9A on the upper surface side is bonded to the protective tape 9B on the lower surface side in a state in which a pulling force directed from both sides 9a toward the central portion is applied, the bonded upper and lower protective tapes 9A and 9B are bent upward at the outsides of both sides 5a of the insulating film 5 due to the pulling force of the protective tape 9A on the upper surface side, and its shape is maintained.

In addition, since the distal end portions 2a of the pair of lead frames 2 are connected to the pattern electrodes 8 closer to the distal end sides than the thin film thermistor portion 6 and are formed to be wider inward than the proximal end sides, it is possible to increase a bonding area with the insulating film 5 arranged further inward than the outer corners 2b and having a small bonding area using the wide distal end portion 5a so as to keep the sensor portion 3 flat and stable. Note that, since the distal end portions 2a of the lead frames 2 are arranged closer to the distal end sides than the thin film thermistor portion 6 and are connected to the pattern electrodes 8, the area of the thin film thermistor portion 6 is not narrowed even when the distal end portions 2a are made wider inward.

Note that the technical scope of the present invention is not limited to the above-described embodiments, and various modifications can be made without departing from the gist of the present invention.

### REFERENCE NUMERALS

1: temperature sensor, 2: lead frame, 2b: outer corner of lead frame, 3: sensor portion, 4: holding part, 5: insulating film, 5a: Both sides of insulating film, 6: thin film thermistor portion, 7: comb-type electrode, 7a: comb part, 8: pattern electrode, 9A and 9B: protective tape, 9a: both sides of protective tape

1. A temperature sensor comprising:
a pair of lead frames;
a sensor portion connected to the pair of lead frames; and
an insulating holding part fixed to the pair of lead frames and configured to hold the pair of lead frames,
wherein the sensor portion comprises:
an insulating film having an upper surface to which the pair of lead frames are bonded;
a thermistor portion made of a thermistor material that is provided to the upper surface of the insulating film;
a pair of electrodes formed on the thermistor portion so as to face each other;
a pair of pattern electrodes each having one end connected to the pair of electrodes and the other end connected to the pair of lead frames and patterned in the upper surface of the insulating film; and
a pair of insulating protective tapes bonded to each other to hold the pair of lead frames and the sensor in a vertical direction,
wherein both sides of the insulating film are arranged in the vicinity of and inside outer corners on bonding surface sides of the pair of lead frames, and
both sides of the pair of protective tapes are bent outward from both sides of the insulating film toward an upper surface side.

2. The temperature sensor according to claim 1, wherein the protective tape on the upper surface side is bonded to the protective tape on a lower surface side in a state in which a pulling force directed from both sides of the protective tape toward a central portion thereof is applied.

3. The temperature sensor according to claim 1, wherein distal end portions of the pair of lead frames are connected to the pattern electrodes closer to distal end sides than the thermistor portion and are formed to be wider inward than proximal end sides.

4. The temperature sensor according to claim 1, wherein the thermistor portion is a thin film thermistor portion made of a thermistor material that is patterned on the upper surface of the insulating film, and
the pair of electrodes are a pair of comb-type electrodes having a plurality of comb parts on at least one of upper and lower sides of the thin film thermistor portion and patterned so as to face each other.
